(19) United States
(12) Patent Application Publication
(10) Pub. No.: US 2018/0011622 A1
(43) Pub. Date: Jan. 11, 2018

(54) SYSTEM AND METHOD FOR DYNAMIC VISUAL REPRESENTATION AND ANALYSIS OF A WEBSITE TRAFFIC

(71) Applicant: IM Creator Ltd., New York, NY (US)

(72) Inventor: Jonathan SARAGOSSI, Tel Aviv (IL)

(73) Assignee: IM Creator Ltd., New York, NY (US)

(21) Appl. No.: 15/641,833

(22) Filed: Jul. 5, 2017

Related U.S. Application Data
(60) Provisional application No. 62/358,622, filed on Jul. 6, 2016.

(51) Int. Cl. G06F 3/0481; G06F 17/22; H04L 12/26; H04L 29/08

(52) U.S. Cl. CPC G06F 3/04817; H04L 67/22; G06F 17/2247; H04L 43/045; H04L 67/306

(57) ABSTRACT

A system and method for dynamic visual representation and analysis of a website traffic are provided. The method includes analyzing at least one website to identify its contents; generating a visual dashboard of website information, wherein the visual dashboard comprises a plurality of segments wherein each segment represents a portion of the at least one website of the identified website's contents; monitoring real-time traffic to the website; identifying, based on the monitored website traffic, a plurality of users currently browsing at least a portion of the at least one website; and generating, for each identified user of the plurality of users, access information for display on the visual dashboard, wherein an icon for each of the plurality of users is displayed within the visual dashboard and wherein the icon represents at least an interaction of each user with the portion of the at least one website.

### CROSS-REFERENCE TO RELATED APPLICATIONS

This application claims the benefit of U.S. Provisional Application No. 62/358,622 filed on Jul. 6, 2016, the contents of which are hereby incorporated by reference.

### TECHNICAL FIELD

The present disclosure relates generally to information visualization and more particularly to visual representation and analysis of a website's visitors.

### BACKGROUND

The Internet currently plays a large role in modern commerce, and it is crucial for every business, large or small, to have a presence on the web. Many businesses have a publicly available website that can be accessed by potential customers. A website is a set of related web-pages typically served from a single web domain, which enable business owners to easily promote their goods and services on the Internet.

Large websites face many obstacles in optimizing their site as the number of their visitors increases. The volume and content of popular sites can grow exponentially over short periods of time, and sites must adapt with the increasing traffic. With the rising numbers, it can become increasingly more difficult for the manager of a website (the “webmaster”) to properly oversee the desired execution of the website.

Because of the complexity of website development, there is a need for a central system to manage and control website development. Known systems for managing and controlling website development include software configuration management systems, document management systems, and database publishing systems.

There are several disadvantages associated with these website development systems. For instance, many of these systems to not allow for real-time website visitor information to be viewed and analyzed. This can be a crucial tool in understanding how clients are engaging with a site in general, and with which elements of the site in particular.

Another disadvantage of known website development systems is that they do not track, nor are they capable of identifying, user satisfaction with the website. Since website files are continually added, removed, changed, moved, and renamed, it is essential to track user satisfaction in order to understand the user interaction and to increase the conversion rate, which indicates the number of visitors who take a desired action while visiting the website. These include purchasing an item or spending a predetermined period of time viewing an element. The ability to immediately identify users' interaction can therefore be essential for website owners.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for dynamic visual representation of a real-time website traffic. The method comprises analyzing at least one website to identify its contents; generating a visual dashboard of website information, wherein the visual dashboard comprises a plurality of segments wherein each segment represents a portion of the at least one website of the identified website's contents; monitoring real-time traffic to the website; identifying, based on the monitored website traffic, a plurality of users currently browsing at least a portion of the at least one website; and generating, for each identified user of the plurality of users, access information for display on the visual dashboard, wherein an icon for each of the plurality of users is displayed within the visual dashboard and wherein the icon represents at least an interaction of each user with the portion of the at least one website.

Certain embodiments disclosed herein also include a system for dynamic visual representation of a real-time website traffic. The system comprises a processing circuitry; and a memory, the memory containing instructions that, when executed by the processing circuitry, configure the system to: analyze at least one website to identify its contents; generate a display of website information, wherein the display comprises a plurality of segments wherein each segment represents a portion of the at least one website of the identified website's contents; monitoring real-time traffic to the website; identify, based on the monitored website traffic, a plurality of users currently browsing at least a portion of the at least one website; and generate, for each identified of the plurality of users, user access information on a visual dashboard for a display, wherein an icon for each of the plurality of users is displayed within the visual dashboard and wherein the icon represents at least an interaction of each user with the portion of the at least one website.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 shows a network diagram utilized to describe the various embodiments related to dynamic visual representation of website traffic.

FIG. 2 shows a flowchart describing a method for generating dynamic visual representation of a website's traffic according to an embodiment.

FIG. 3 shows a flowchart describing a method for real-time rendering a unique display of website traffic according to an embodiment.

FIGS. 4A and 4B show dynamic visual representations of a website environment rendered according to an embodiment.

FIG. 5 shows a block diagram of a webmaster device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for dynamic visual representation and analysis of a website traffic. In an embodiment, a management dashboard is rendered to enable real-time monitoring and analysis of the website's traffic. The system further provides tools for automatic monitoring and management of visitors' experiences in real-time based on an analysis of their interaction with the website and elements therein. According to an embodiment, the system is configured to analyze visitors' interaction in the website in real-time.

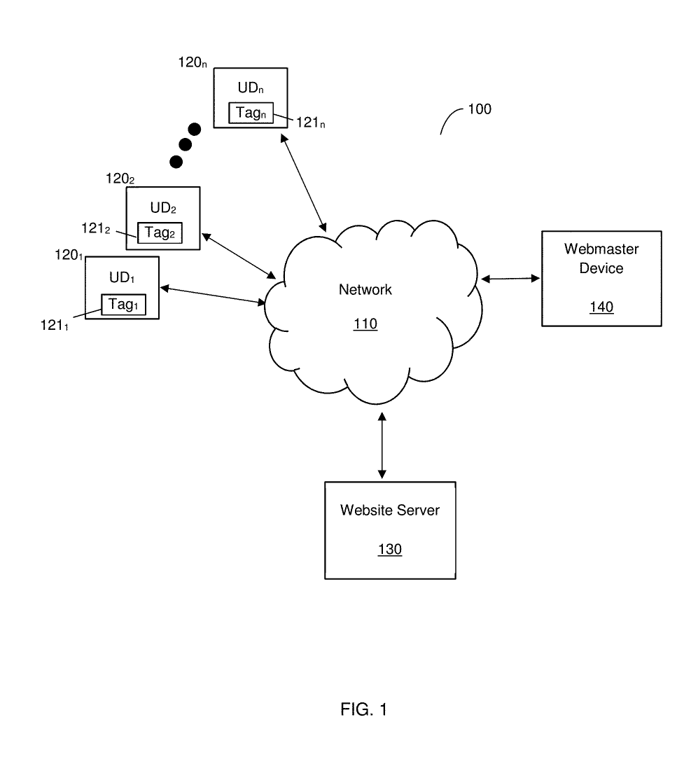

FIG. 1 shows an example network diagram 100 of the system for dynamic visual representation of website traffic according to an embodiment. The network diagram 100 depicts one or more user devices (120₁-120ₙ, hereinafter referred to collectively or singularly as 120 for simplicity purposes), a website server 130, and a webmaster device 140 connected through a network 110. The network 110 may be, but is not limited to, the Internet, the world-wide-web (WWW) and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other wired and mobile computing devices, equipped with browsing, viewing, and other methods of interacting with and accessing websites. The webmaster device 140 may similarly include, but is not limited to, a personal computer (PC), a personal digital assistant (PDA), a mobile phone, a smart phone, a tablet computer, a wearable computing device and other wired and mobile computing devices.

When a user device 120 accesses a website hosted on the website server 130, the website server 130 is configured to track the behavior and actions of that user device 120. In a non-limiting example, when a user device accesses a website hosted on the website server 130 though the network 110, a tracking tag (121₁-121ₙ, hereinafter referred to collectively or singularly as 121 for clarify purposes) is sent to the user device 130. In one embodiment, the tag 121 is sent from the website server 130. The tag 121 may include a cookie, a script, or similar piece of code designed to track the actions of the user device, including but not limited to the webpages visited within the website; the areas clicked on and viewed within each webpage, such as text, images, video, and the like; time spent viewing each webpage and each area within the webpage; tracking the movement of a cursor and the like.

Alternative methods of tracking the interaction of a user device 120 within a website may be implemented. Such methods may include, but are not limited to, tracking an internet protocol (IP) address associated with a user device 120 Each method employed is configured to track the behavior of the user device 120 and the interactions it has with the website.

The webmaster device 140 is configured to access the tags 121, IP addresses, or any tracking associated with each user device 120. In one embodiment, this information is stored within the website server 130, and the webmaster device 140 is configured to access the server 130 and information stored therein through the network 110. In an alternative embodiment, the user device 120 information is sent directly from the user device 120 to the webmaster device via the network 110.

As will be discusses below, the information related to the behavior and interactions of the user device 120 is organized and presented in a visual format, where the visual format is configured to be displayed on the webmaster device 140. This information can be tracked, organized, and displayed in real time, allowing a user of the webmaster device 140 to view and analyze the current traffic of the website.

It should be understood that the embodiments disclosed herein are not limited to the specific architecture illustrated in FIG. 1 and that other architectures may be equally used without departing from the scope of the disclosed embodiments. Specifically, the webmaster device 140 and/or web servers may reside in the cloud computing platform, a different cloud computing platform, or a datacenter. Moreover, in an embodiment, there may be a plurality of web servers 130 and/or webmaster devices 140 operating as described hereinabove and configured to either have one as a standby, to share the load between them, or to split the functions between them.

It should be noted that a single webmaster device 140 is described herein with respect to FIG. 1 merely for simplicity purposes and without limitation on the disclosed embodiments. Multiple webmaster devices, configured to perform the processed described herein, may be utilized in conjunction without departing from the scope of the disclosed embodiments.

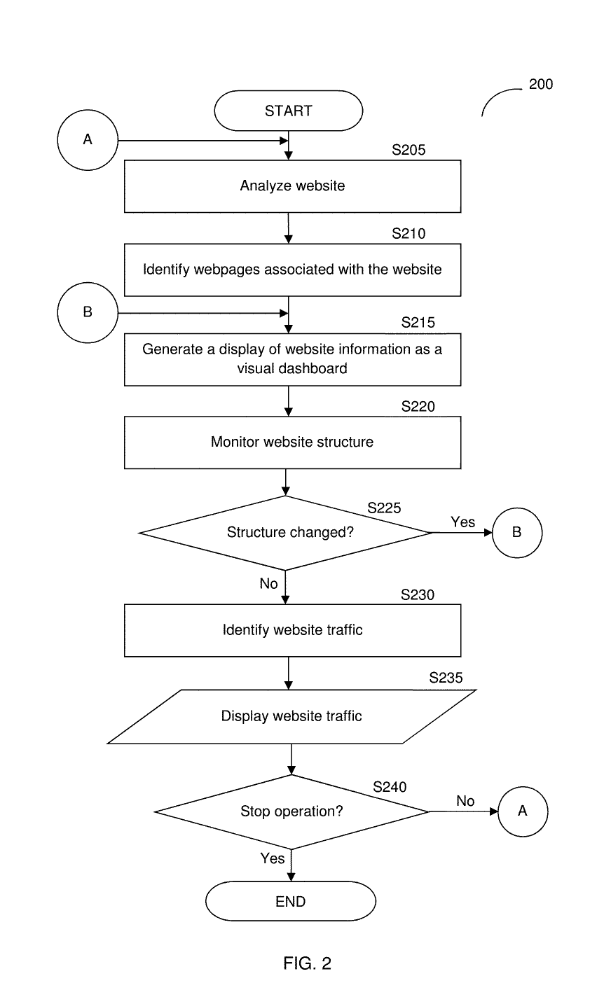

FIG. 2 shows an exemplary and non-limiting flowchart 200 describing an operation of a system for generating a dynamic visual representation of website traffic according to an embodiment.

At S205, the operation starts when at least one website is analyzed to determine its contents. The analysis enables identification of a plurality of portions within a website, e.g., various webpages that make up the website and elements therein. The analysis may be of the domain of the website, a binary code associated therewith, links associated thereto, a combination thereof, and so on.

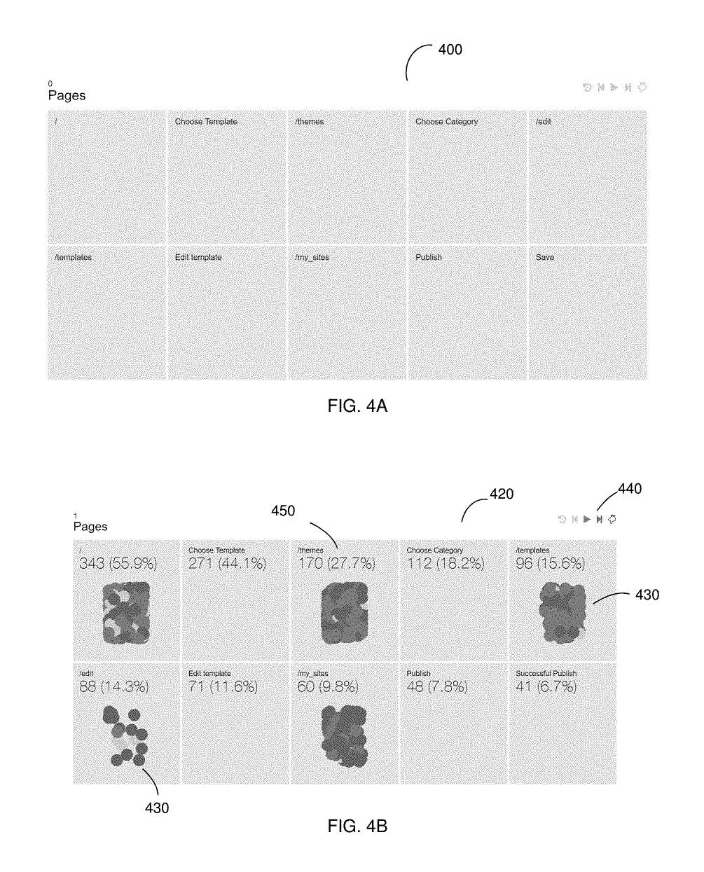

At S210, a plurality of portions associated with the at least one website is identified based on the analysis. At S215, a display of information of the plurality of portions of the at least one website is generated for display as a website management tool on, for example, the webmaster device. According to an embodiment, the display of information includes a chart. The chart is composed of a plurality of display segments wherein each display segment represents a portion of the at least one website. According to an example embodiment, each display segment may be a cell of the chart as further described herein below with respect of FIGS. 4A and 4B that corresponds to a portion of the website, e.g. a webpage.

At S220, the website's structure, i.e., each portion of the website, is continuously monitored. The continuous monitoring ensures identification of changes within the website structure in order to provide accurate and current data associated with the website. At S225, it is checked whether the website structure has changed and if so, execution continues with S215 where a new display representing the modified contents of the website is generated; otherwise, execution continues with S230.

At S230, the traffic to the website is tracked and monitored. In an embodiment, the tracking and/or monitoring is performed, for example by the tag 121 discussed in FIG. 1. It should be noted that the website's traffic being monitor includes various attributes related to users' interaction with each portion of the website. This includes, but not limited to, pages being visited, navigation through the website, time spent on each page and element of the page, sequence of elements and webpages viewed, and the like.

At S235, the monitored website's traffic is displayed on the chart as a visual dashboard. According to an embodiment, a dot is displayed for each user device (e.g., a user device 120) or for a plurality of user devices having at least one common characteristic. The dot movement throughout the chart represents the interaction of each corresponding user device with the corresponding one or more portions of the at least one website. At S240, it is checked whether to stop the operation of the system and if so, execution terminates; otherwise, execution continues with S205.

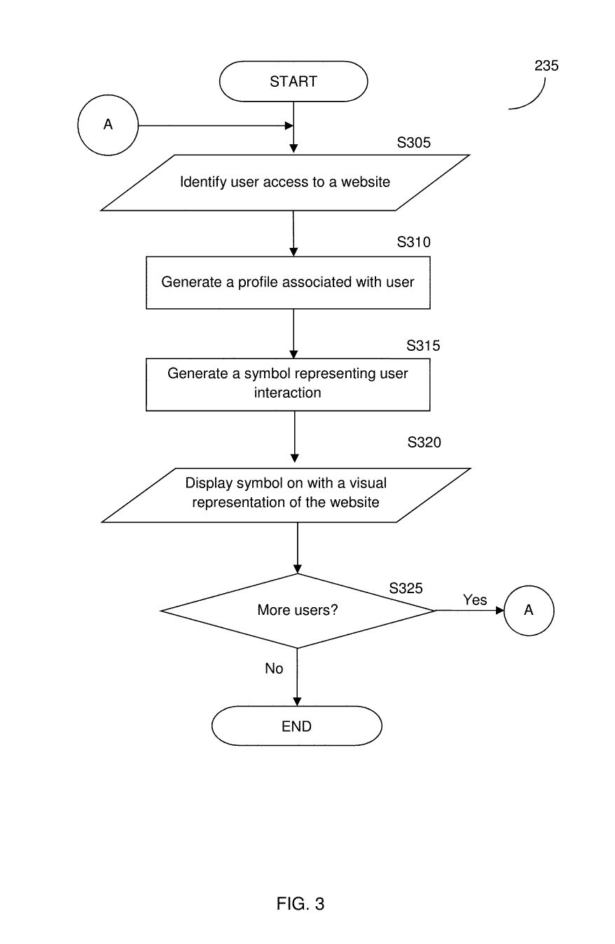

FIG. 3 depicts an example flowchart 300 describing a method for displaying a website's traffic according to an embodiment.

At S305, the operation begins when access of at least one user, e.g. from a user device 120, to at least a portion of a website is identified. According to an embodiment, such identification is enabled by querying a server operating the website, e.g. the website server 130 of FIG. 1. The query may request information regarding the user device 120, such as the tracking tag 121 of FIG. 1.

At S310, a profile associated with the user device is generated. The profile may represent a conversion potential of the user device 120. The profile may include the browsing history, an IP address, and a type associate with a user of the user device. The associated type may include a first-time visitor or a repeat visitor, a customer who has previously purchased an item or service from the website, and so on. In an embodiment, the profile further represents a score generated based on the information associated with the user device. The score may indicate the conversion potential, namely the probability that the user device will transition, e.g., from a visitor to client. The profile may be updated on a real-time basis as the user device navigates the website.

At S315, a representative symbol is generated to indicate behavior and interactions of the generated profile. In a non-limiting example, a dot is a representative symbol being associated with the profile, where a single dot corresponds to at least one user device. In an embodiment, similar dots may be representative of a plurality of user devices, wherein the plurality of user devices share a common characteristic. For example, all user devices that have been identified as first-time visitors to the website may be represented as a blue dot, and second-time repeat visitors may be represented as a red dot.

At S320, the symbol is displayed within a visual representation of the website, such as a chart. For example, the dot may be placed within a segment of the chart signifying that a user device is accessing a home page of the website. In an embodiment, the dot is configured to move within the visual depiction of the chart, where the movement corresponds to the interaction of the user device with the different portions of the website. For example, if a user device accesses multiple elements with a webpage, such as clicking on an image and then playing a video, the dot will shift within that segment of the chart in real time, where segments within the chart represent various website elements.

At S325, it is checked whether additional user devices are currently accessing the website. If so, the process continues with 305; otherwise it ends.

According to the disclosed embodiments, the methods discussed with references are performed by a computing device, such as, but not limited to, the user device 140.

FIGS. 4A and 4B depict simulations of a website management tool according to an embodiment. In FIG. 4A a chart 400 is shown, e.g. the chart discussed in FIGS. 2 and 3, where various cells within the chart represent different portions of a website. In this embodiment, each portion corresponds to a particular part of the website, e.g., web pages.

In FIG. 4B users' traffic throughout the different portions of the website are displayed on the chart 420 of the website management tool as dots of different shades 430. In this embodiment, the shade of each dot may represent the user's profile as described hereinabove with respect of FIG. 3. In further embodiments the dots can be displayed in different colors or other means known in the art to distinguish between different icons. The website management tool may further comprise a control bar 440 configured to cycle through the display of users' traffic at certain time intervals.

As shown in FIG. 4B, the dots present an easily readably depiction of the current user interaction with the website. Additionally, load capacities and other relevant statistics 450 may be presented within the chart. Thus, the visual information allows a webmaster to survey the interaction with the website in real-time and respond appropriately.

The dots are rendered on the chart based on real-time identification of a user's interaction with one or more portions of the website and are corresponding thereto. Therefore, users' interaction throughout the website is shown on the chart and a user managing the website is capable of providing content to users in order to enhance their experience and/or monetization thereof. Such content may be for example, a widget, an ad, a video-ad, a pop-up, a chat window, and so on in response to that user's interactions with website. The content may include a certain discount or special offer. According to further embodiments, the webmaster device may cause re-navigation of a user in the website, i.e., automatically redirecting the user from a first portion of the website to a second portion.

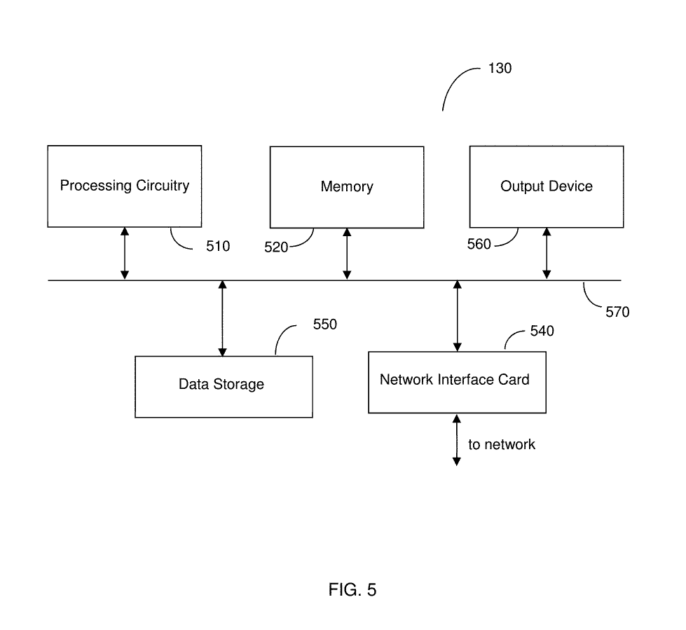

FIG. 5 depicts an example embodiment of the webmaster device 140 generating a dynamic visual representation of a website's traffic according to an embodiment. The webmaster device 140 includes a processing circuitry 510 coupled to a memory 520 and a network interface (NIC).

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), graphics processing unit (GPUs) and the like, or any other hardware logic components that can perform calculations or other manipulations of information.

The memory 520 contains therein instructions that when executed by the processing circuitry 510 results in the visual representation of a website's traffic as further described herein. Specifically, the memory may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code).

The processing circuitry 510 is further coupled to a data storage unit 550 configured to store data related to the website's current traffic, history, content to be provided to users, and other relevant data.

The processing circuitry 510 is further coupled to a network interface card (NIC) 540 that is configured to be operably connected to a network (not shown) that allows a webmaster device 140 to access the web servers and/or user devices.

An output device 560 is configured to display the rendered the visual displays. Each to the components may be operably connected via a bus 570.

It should be noted that systems that provide software as a service (SaaS) are specifically included herein. In such systems, computations may be done by a remote server that enables the visualization, and as may be applicable to the corresponding input means (e.g. mobile device, desktop device, etc.), which can be observed and/or controlled by a remote administrator, remote operator and/or a client/user. Hence each of the elements shown in FIG. 5 may be moved in whole, in part, or otherwise duplicated in whole or in part at a remote location and communicatively coupled over a network. The network may comprise a local area network (LAN), wide area network (WAN), metro area network (MAN), the worldwide web (WWW), and the likes, whether wired or wireless.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for dynamic visual representation of a real-time website traffic, comprising:
analyzing at least one website to identify its contents;
generating a visual dashboard of website information, wherein the visual dashboard comprises a plurality of segments wherein each segment represents a portion of the at least one website of the identified website's contents;
monitoring real-time traffic to the website;
identifying, based on the monitored website traffic, a plurality of users currently browsing at least a portion of the at least one website; and
generating, for each identified user of the plurality of users, access information for display on the visual dashboard, wherein an icon for each of the plurality of users is displayed within the visual dashboard and wherein the icon represents at least an interaction of each user with the portion of the at least one website.

2. The method of claim 1, wherein the user access information is generated in real time with respect to the interaction of each user with the portion of the at least one website.

3. The method of claim 1, wherein the visual dashboard is a chart, and wherein the icon is displayed within the plurality of segments within the chart.

4. The method of claim 1, wherein the icons further comprise visual differences configured to distinguish between each of the plurality of users.

5. The method of claim 1, wherein the portion of the at least one website includes at least one of: a webpage, a multimedia element within a webpage, and an HTML element of the at least one website.

6. The method of claim 1, wherein the identifying the plurality of users further comprises:
identifying for each of the plurality of users at least one of: a browsing history, an IP address, and a type associated with a user.

7. The method of claim 6, wherein the type associated with a user includes at least one of: a first-time visitor, a repeat visitor, a user who has previously completed a purchased on the website.

8. The method of claim 1, wherein identifying the plurality of users further comprises:
assigning a tracking tag to a user when the user accesses the at least one website.

9. The method of claim 8, wherein the tracking tag is configured to track the actions of the user within the website, and wherein the tracking tag includes at least one of: a cookie, a script, a piece of code.

10. A non-transitory computer readable medium having stored thereon instructions for causing a processing circuitry to execute a process, the process comprising:
analyzing at least one website to identify its contents;
generating a display of website information, wherein the display comprises a plurality of segments wherein each segment represents a portion of the at least one website of the identified website's contents;
monitoring real-time traffic to the website;
identifying, based on the monitored website traffic, a plurality of users currently browsing at least a portion of the at least one website; and
generating, for each identified user of the plurality of users, access information on a visual dashboard for a display, wherein an icon for each of the plurality of users is displayed within the visual dashboard and wherein the icon represents at least an interaction of each user with the portion of the at least one website.

11. A system for dynamic visual representation of a real-time website traffic, comprising:
a processing circuitry; and
a memory, the memory containing instructions that, when executed by the processing circuitry, configure the system to:
analyze at least one website to identify its contents;
generate a display of website information, wherein the display comprises a plurality of segments wherein each segment represents a portion of the at least one website of the identified website's contents;
monitoring real-time traffic to the website;
identify, based on the monitored website traffic, a plurality of users currently browsing at least a portion of the at least one website; and
generate, for each identified of the plurality of users, user access information on a visual dashboard for a display, wherein an icon for each of the plurality of users is displayed within the visual dashboard and wherein the icon represents at least an interaction of each user with the portion of the at least one website.

12. The system of claim 11, wherein the user access information is generated in real time with respect to the interaction of each user with the portion of the at least one website.

13. The system of claim 11, wherein the visual dashboard is a chart, and wherein the icon is displayed within the plurality of segments within the chart.

14. The system of claim 11, wherein the icons further comprise visual differences configured to distinguish between each of the plurality of users.

15. The system of claim 11, wherein the portion of the at least one website includes at least one of: a webpage, a multimedia element within a webpage, and an HTML element of the at least one website.

16. The system of claim 11, wherein the system is further configured to:
identify for each of the plurality of users at least one of: a browsing history, an IP address, and a type associated with a user.

17. The system of claim 16, wherein the type associated with a user includes at least one of: a first-time visitor, a repeat visitor, a user who has previously completed a purchased on the website.

18. The system of claim 11, wherein the system is further configured to:
assign a tracking tag to a user when the user accesses the at least one website.

19. The system of claim 18, wherein the tracking tag is configured to track the actions of the user within the website, and wherein the tracking tag includes at least one of: a cookie, a script, a piece of code.
